(19) United States
(12) Patent Application Publication
(10) Pub. No.: US 2007/0243108 A1
(43) Pub. Date: Oct. 18, 2007

(54) Sulfur detector for gaseous fuels

(75) Inventor: Gordon A. Israelson, Murrysville, PA (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/403,568

(22) Filed: Apr. 13, 2006

(51) Int. Cl. B32B 27/04

(52) U.S. Cl. 422/88

(57) ABSTRACT

In one embodiment the present invention provides for a sulfur detector 8 that comprises a gaseous flow 2, and a zeolite material disposed in the gaseous flow. Although various types of sulfur can be detected, the present invention is particularly suited for dimethyl sulfide and organic sulfur. The zeolite material changes color in the presence of sulfur by physically binding sulfur from the gaseous flow 2, which is also referred to as physical adsorption. The zeolite material is regenerable, and regenerating the zeolite material releases sulfur and returns to an original color.

### FIELD OF THE INVENTION

This invention relates to the detection of sulfur in gas streams, particularly in the hydrocarbon based fuel gas streams used in fuel cell technology

### BACKGROUND

Pipeline natural gas is the primary fuel of choice for distributed fuel cell-based power generation systems because of its abundant supply and well-developed infrastructure. By using a fuel processing system at the unit inlet to reform the methane and higher hydrocarbons in natural gas, both solid oxide fuel cells and molten carbonate fuel cells will convert chemical energy directly into electrical energy for power distribution. Although processing of natural gas to remove sulfur is usually carried out close to the point of extraction, the processing may leave residual hydrogen sulfide as a contaminant at low concentration (e.g. 1-2 mg/m³). In addition to the naturally occurring hydrogen sulfide, pipeline natural gas contains dimethyl sulfide or other organic sulfur species that have been intentionally added as odorants.

The fuel reforming process requires heat, water vapor and a catalyst that enhances the chemical reaction rate. The most commonly used catalysts are nickel based. At the natural gas reforming temperature, the catalyst is highly susceptible to conversion into a metal sulfide if sulfur is present in the gas feed. This inactivates the catalyst and stops the reforming process. Therefore it is necessary to detect and remove the sulfur from the gas flow to permit the desired fuel reforming to occur. In addition, sulfur that makes it through the reforming process will contribute to air pollution.

Advancement in the art of purifying materials have been made, such as with Kataoka, U.S. Pat. No. 6,828,141. However, this process does not offer advantages on the particular detection of sulfur. Other difficulties with the prior art also exist, some of which will be apparent upon further reading.

What is needed is a method and apparatus that can easily detect sulfur in a gaseous fuel flow.

### SUMMARY OF THE INVENTION

With the foregoing in mind, methods and apparatuses consistent with the present invention, which inter alia facilitates the detection of sulfur in a gaseous fuel flow. Sulfur needs to be removed from gaseous fuels. It is a natural contaminant found in natural gas, and can also be an added containment as part of the odorization process. However, sulfur is also very damaging to catalysts and fuel cells, and causes reduction in performance. The present invention offers a simple and reusable way to detect sulfur in a gaseous fuel flow.

Copper exchanged Zeolite-Y is very good at physically adsorbing, though not covalently bonding, dimethyl sulfide and organic sulfur compounds. It also distinctly changes color when it does this, changing from a light green to a dark brown. Since the modified Zeolite is able to adsorb sulfur odorants at low concentrations and have a distinct macroscopic change, it can be used to detect sulfur in gas flow. The detection of the change to the modified Zeolite may be done visually or with an optical detector.

The modified Zeolite can be added to a gas flow, or may be portioned off in a branch, similar to a pilot light. Since the modified Zeolite binds sulfur odorants non-covalently, it can be regenerated by using heat and blowing gas over it.

These and other objects, features, and advantages in accordance with the present invention are provided particular embodiments by a sulfur detector that comprises a gaseous flow, and a zeolite material disposed in the gaseous flow. Although various types of sulfur can be detected, the present invention is particularly suited for dimethyl sulfide and organic sulfur. The zeolite material changes color in the presence of sulfur by physically binding sulfur from the gaseous flow, which is also referred to as physical adsorption. The zeolite material is regenerable, and regenerating the zeolite material releases sulfur and returns to an original color.

In particular embodiments, the gaseous flow is a fuel. The zeolite material is a metal exchanged zeolite-Y, and in particular the metal is copper. The zeolite material may be disposed in a side flow of the gaseous flow, and the side flow may be used to calibrate the sensitivity of the sulfur detector.

Other embodiments further comprise an optical detector, the optical detector being capable of measuring the change in color of the zeolite material. The optical detector can be calibrated to approximate a concentration of sulfur in the gaseous flow by the degree of color change to the zeolite material. The zeolite material changes color when the concentration of sulfur in the gaseous flow is at least 1 mg/m³, and is regenerated by heating to about 300° C. and exposing the zeolite material to a gas flow. The regeneration and monitoring can be performed after removing the zeolite material from the gaseous flow, for example, physically taking the detector out of the gas flow.

In another embodiment the present invention provides for a sulfur detector that comprises a gaseous flow, a copper exchanged zeolite-Y film on a substrate disposed within the gaseous flow, and an optical detector. The zeolite-Y film changes color in the presence of sulfur by physically binding sulfur in the gaseous flow when the concentration of sulfur in the gaseous flow is at least 1 mg/m³. The optical detector is capable of measuring the change in color of the zeolite-Y. The zeolite-Y is regenerated by heating to about 300° C. and exposing the zeolite-Y to a gas, whereby the gas flow carries away desorbed sulfur compounds.

In particular embodiments the heating to regenerate the zeolite-Y is performed by directly heating the zeolite-Y with a heater. Otherwise the heating to regenerate the zeolite-Y is performed by bringing the gas flow to about 300° C.

In still another embodiment the present invention provides for a method of detecting sulfur in a gaseous flow that comprises depositing a thin film of a metal exchanged zeolite onto a substrate then disposing the zeolite into the gaseous flow. Observing the zeolite for a color change and recognizing the color change and inferring the presence of sulfur in the gaseous flow.

In further particular embodiment of the method, the metal exchanged zeolite is copper exchanged zeolite-Y. The substrate may be an integral part of a system for the gaseous flow. Also observing the zeolite for a color change may be performed by an optical detector.

Other embodiments of the present invention also exist, which will be apparent upon further reading of the detailed description.

### BRIEF DESCRIPTION OF THE FIGURES

The invention is explained in more detail by way of example with reference to the following drawing:

FIG. 1 illustrates a schematic of how the present invention can be used to test a sample gaseous flow for the presence of dimethyl sulfide and organic sulfur.

### DETAILED DESCRIPTION OF THE INVENTION

The present invention provides for a system and method for a quickly detecting dimethyl sulfide and organic sulfur in gaseous fuel flows. In the prior art, in-line, quick response sulfur detectors are not able to detect dimethyl sulfide or organic sulfurs such as mercaptans and thiophenes. They are suitable for detection of hydrogen sulfide alone. Analysis that permitted detection of all sulfur compounds required the use of discrete grab samples that were subsequently processed in gas chromatograph equipped with a special detector. The elapsed time from taking the sample to completion of the analysis is about twenty minutes. This can be problematic, since even small amounts of sulfur in a gaseous fuel flow can ruin sensitive catalysts and stop fuel reforming or inactivates fuel cells in a short time. In addition, the gas chromatograph and special sulfur detector is very expensive compared to the simplicity of this invention.

The present invention uses a thin layer of metal exchanged zeolite (zeolite), which is typically mounted onto a firm substrate, and then exposed to a gaseous fuel flow. As little as 1 mg/m³ of a sulfur compound will turn the layer of the zeolite from a light green color to a dark brown. There are various types of zeolites, but the kind known as zeolite-Y is particularly suited to the present invention due to its pore size, its hydrophobic nature and distinct color changes. The metal of the metal exchanged zeolite can be of a variety of sorts, such as silver, zinc, iron, and in particular, copper.

The sulfur adsorption is a physical (non-covalent) bonding, and is therefore reversible. To break the physical bonds of the adsorbed sulfur, heat may be applied. Temperatures of approximately 300° C. will reverse the sulfur adsorption releasing the sulfur to the environment. This may be done by directly heating the zeolite with a heater, or by passing a hot gas over the material. After releasing the sulfur, the zeolite will return to the light green color. The copper exchanged zeolite-Y returns to its original light green color immediately upon release of the adsorbed sulfur compounds.

To detect the sulfur, therefore, can be as simple as noticing a color change. The zeolite material may be placed on a probe that is inserted into a gaseous flow and then removed and inspected. Or a window may be present to observe the zeolite material within the flow. Non manual options include monitoring the zeolite with an optical sensor. Optical sensors are known in the art, and, for example, will typically register a drop in voltage as the object that they are measuring darkens.

Optical sensor can be extremely accurate, and therefore an optical sensor can be easily calibrated to the change in zeolite color and measured against gaseous flow. This will produce an accurate measurement of the amount of sulfur in the flow. The zeolite does not even have to be placed directly within the gaseous flow. A side flow, comparable to that used with a pilot light, may be diverted to the sensor.

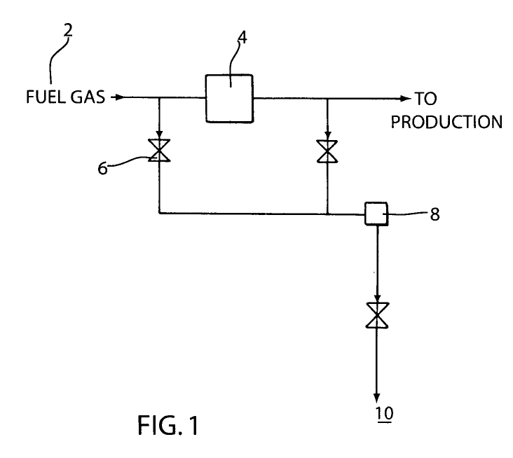

FIG. 1 illustrates one such embodiment. Gaseous fuel 2, enters the system. In this schematic, the fuel passes through a desulfurizer 4. Valves 6 may be opened to divert a small portion of the fuel flow to the detector 8, either before or after desulfurization. The gas that leaves the detector 10 may be reentered into the fuel stream or disposed. It is good practice to use a calibration gas with known level of sulfur contaminants to calibrate the sensitivity level of the detector.

As discussed, a particular type of zeolite being used is copper exchanged zeolite Y. Zeolite is a silicon aluminum molecule, and Y refers to the structure of the zeolite being regular with voids and other chemical properties such as being relatively hydrophobic. The zeolite is formed into a thin layer about 0.05 mm or less, although this thickness may be varied. This is then put onto a substrate. The substrate provides structural support, and can be of a variety of shapes and sizes, and may even be part of the gaseous flow apparatus.

In one embodiment the present invention provides for a sulfur detector that comprises a gaseous flow, and a zeolite material disposed in the gaseous flow. Although various types of sulfur can be detected, the present invention is particularly suited for dimethyl sulfide and organic sulfur. The zeolite material changes color in the presence of sulfur by physically binding sulfur from the gaseous flow, which is also referred to as physical adsorption. The zeolite material is regenerable, and regenerating the zeolite material releases sulfur and returns to an original color.

In particular embodiments, the gaseous flow is a fuel. The zeolite material is a metal exchanged zeolite-Y, and in particular the metal is copper. The zeolite material may be disposed in a side flow of the gaseous flow, and the side flow may be used to calibrate the sensitivity of the sulfur detector.

Other embodiments further comprise an optical detector, the optical detector being capable of measuring the change in color of the zeolite material. The optical detector can be calibrated to approximate a concentration of sulfur in the gaseous flow by the degree of color change to the zeolite material. The zeolite material changes color when the concentration of sulfur in the gaseous flow is at least 1 mg/m³, and is regenerated by heating to about 300° C. and exposing the zeolite material to a gas flow. The regeneration and monitoring can be performed after removing the zeolite material from the gaseous flow, for example, physically taking the detector out of the gas flow.

In another embodiment the present invention provides for a sulfur detector that comprises a gaseous flow, a copper exchanged zeolite-Y film on a substrate disposed within the gaseous flow, and an optical detector. The zeolite-Y film changes color in the presence of sulfur by physically binding sulfur in the gaseous flow when the concentration of sulfur in the gaseous flow is at least 1 mg/m³. The optical detector is capable of measuring the change in color of the zeolite-Y. The zeolite-Y is regenerated by heating to about 300° C. and exposing the zeolite-Y to a gas, whereby the gas flow carries away desorbed sulfur compounds.

In particular embodiments the heating to regenerate the zeolite-Y is performed by directly heating the zeolite-Y with a heater. Otherwise the heating to regenerate the zeolite-Y is performed by bringing the gas flow to about 300° C.

In still another embodiment the present invention provides for a method of detecting sulfur in a gaseous flow that comprises depositing a thin film of a metal exchanged zeolite onto a substrate then disposing the zeolite into the gaseous flow. Then observing the zeolite for a color change and recognizing the color change and inferring the presence of sulfur in the gaseous flow.

In a further particular embodiment of the method, the metal exchanged zeolite is copper exchanged zeolite-Y. The substrate may be an integral part of a system for the gaseous flow. Also observing the zeolite for a color change may be performed by an optical detector.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and any and all equivalents thereof.

What is claimed is:

1. A sulfur detector comprising:
a gaseous flow; and
a zeolite material disposed in said gaseous flow, wherein said zeolite material changes color in the presence of sulfur by physically binding sulfur from said gaseous flow;
wherein said zeolite material is regenerable, and wherein regenerating said zeolite material releases sulfur and returns to an original color.

2. The sulfur detector of claim 1, wherein said gaseous flow is a fuel.

3. The sulfur detector of claim 1, wherein said zeolite material is a metal exchanged zeolite-Y.

4. The sulfur detector of claim 3, wherein said metal is copper.

5. The sulfur detector of claim 1, wherein said zeolite material is disposed in a side flow of said gaseous flow.

6. The sulfur detector of claim 5, wherein said side flow is used to calibrate the sensitivity of said sulfur detector.

7. The sulfur detector of claim 1, further comprising an optical detector, wherein said optical detector is capable of measuring the change in color of said zeolite material.

8. The sulfur detector of claim 7, wherein said optical detector is calibrated to approximate a concentration of sulfur in said gaseous flow by the degree of color change to said zeolite material.

9. The sulfur detector of claim 1, wherein said zeolite material changes color when the concentration of sulfur in said gaseous flow is at least 1 mg/m³.

10. The sulfur detector of claim 1, wherein said zeolite material is regenerated by heating to about 300° C. and exposing said zeolite material to a gas flow.

11. The sulfur detector of claim 10, wherein the regeneration is performed after removing said zeolite material from said gaseous flow.

12. The sulfur detector of claim 1, wherein said zeolite material is monitored after removing said zeolite material form said gaseous flow.

13. A sulfur detector comprising:
a gaseous flow;
a copper exchanged zeolite-Y film on a substrate disposed within said gaseous flow; and
an optical detector;
wherein said zeolite-Y film changes color in the presence of sulfur by physically binding sulfur in said gaseous flow;
wherein said zeolite-Y changes color when the concentration of sulfur in said gaseous flow is at least 1 mg/m³;
wherein said optical detector is capable of measuring the change in color of said zeolite-Y;
wherein said zeolite-Y is regenerated by heating to about 300° C. and exposing said zeolite-Y to a gas, whereby said gas flow carries away desorbed sulfur compounds.

14. The sulfur detector of claim 13, wherein the heating to regenerate said zeolite-Y is performed by directly heating said zeolite-Y with a heater.

15. The sulfur detector of claim 13, wherein the heating to regenerate said zeolite-Y is performed by bringing said gas flow to about 300° C.

16. A method of detecting sulfur in a gaseous flow comprising:
depositing a thin film of a metal exchanged zeolite onto a substrate;
disposing said zeolite into said gaseous flow;
observing said zeolite for a color change;
recognizing said color change and inferring the presence of sulfur in said gaseous flow.

17. The method of claim 16, wherein said metal exchanged zeolite is copper exchanged zeolite-Y.

18. The method of claim 16, wherein said substrate is an integral part of a system for said gaseous flow.

19. The method of claim 16, wherein observing said zeolite for a color change is performed by an optical detector.
